(19) United States
(12) Patent Application Publication
(10) Pub. No.: US 2006/0055647 A1
(43) Pub. Date: Mar. 16, 2006

(54) Method for resolving display nonuniformity

(75) Inventors: Bou-Chi Chang, Hsinchu City (TW); Yu-Xian Chang, Shulin City (TW); Hsin-Mao Huang, Alian Shiang (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 10/984,798

(22) Filed: Nov. 10, 2004

(30) Foreign Application Priority Data
Sep. 10, 2004 (TW) 93127377

(51) Int. Cl. G09G 3/36

(52) U.S. Cl. 345/87

(57) ABSTRACT

A method for resolving display nonuniformity is disclosed. The method comprises the steps of: (a1) turning on a display screen; (a2) dividing the display screen into a plurality of areas; (a3) using the center line as a baseline in each area for separating the pixel capacitors of each area into left pixel capacitors and right pixel capacitors, and turning on the pixel capacitor arranged at the center line; (a4) turning on a left pixel capacitor arranged most adjacent to the center line after the pixel capacitor at the center line is turned on; (a5) turning on a right pixel capacitor arranged most adjacent to the center line after the pixel capacitor at the near-most left side of the center line is turned on; and (a6) turning on a left pixel capacitor just next to the previous turned-on left pixel capacitor and then turning on a right pixel just next to the previous turned-on right capacitor, and so on, i.e. the pixel capacitor are being turned on starting from the center line and progressing outwardly until all of the pixel capacitors of the area are turned on.

### FIELD OF THE INVENTION

The present invention relates to a method for solving display delay, and more practically, to a method for improving the display quality of a liquid crystal display (LCD) by changing the turn-on sequence of pixel capacitors.

### BACKGROUND OF THE INVENTION

In just a few decades, the development of electronic products has exceeded that of other industries. Especially for those compute-related and audio/video electronic products, the progress is in fast path following the pressing demands for work and leisure requirements of people. In this regard, there are new electronic products in the market almost in daily basis. Take the display product for instance; the conventionally used display is constituted of a Cathode Ray Tube (CRT), which usually has the following drawbacks:
1. Since the conventional display is not equipped with flat screen, it is often suffering from a phenomenon of image twisting during watching.
2. The conventional cathode ray tube has comparatively larger power consumption, that is, the cathode ray tube will consume a conceivable more electricity that, as the consequence, the display of cathode ray tube suffers from the phenomena of high temperature and heat.
3. The size of the conventional display is bulky since it is restricted by the size of the cathode ray tube therein, so that a certain larger space is required for storing and operating the conventional display.

New generation of displays including liquid crystal display (LCD), and plasma display, etc, are developed by manufacturers in view of the aforementioned deficiencies of the conventional display. With the maturation of the LCD manufacturing technique, the price of the LCD is decreased to a degree almost equal to that of the conventional display of cathode ray tube. Since the LCD has the advantages of low radiation, low power consumption, small size, and larger visual angle, it is a favorite of mostly common users.

The LCD display nowadays is mostly being implemented as computer monitor, liquid crystal TV, and displaying device and other 3C electronic products, such as mobile phone, digital camera, etc. The LCD provides a widespread application. Please refer to FIG. 1, which is a schematic illustration showing a turn-on operation of pixel capacitors in the screen of a conventional LCD. As seen in FIG. 1, the screen is divided into a plurality of areas, and the pixel capacitors within each area are turned on starting from the leftmost pixel Hs (l) and progressing toward the right in sequence (or, from the right side toward the left side) until all of the pixel capacitors including the rightmost pixel Hs(N) are turned on. Next, a process of pixel elimination (i.e. discharging of pixel capacitor) is performed. These steps are performed repeatedly to form the entire screen. However, rear sections of each areas of a screen usually suffer from a phenomenon of color lightening caused by insufficient charging time of pixel capacitor, for example, that an expected black area becomes a gray area and thus several stripes of lighter color are formed on the screen affecting the accuracy of the screen. In order to overcome this phenomenon, the present invention provides a method for changing the turn-on sequence of the pixel capacitors so as to improve the displaying quality of LCD.

### SUMMARY OF THE INVENTION

The present invention is provided in view of the conventional drawbacks described above. The primary object of the invention is to provide a method for solving display delay capable of minimizing the phenomenon of color lightening formed on partial areas of a screen by changing the turn-on sequence of the pixel capacitors, that is, the pixel capacitors in a area of a screen are turned on starting from those arranged at the center line of the area and progressing outwardly basing on the proximity to the center line.

To achieve the abovementioned object, the present invention provides a method for resolving display nonuniformity, comprising the steps of:
(a1) turning on a display screen;
(a2) dividing the display screen into a plurality of areas;
(a3) using the center line as a baseline in each area for separating the pixel capacitors of each area into left pixel capacitors and right pixel capacitors, and turning on the pixel capacitor arranged at the center line;
(a4) turning on a left pixel capacitor arranged most adjacent to the center line after the pixel capacitor at the center line is turned on;
(a5) turning on a right pixel capacitor arranged most adjacent to the center line after the pixel capacitor at the near-most left side of the center line is turned on; and
(a6) turning on a left pixel capacitor just next to the previous turned-on left pixel capacitor and then turning on a right pixel just next to the previous turned-on right capacitor, and so on, i.e. the pixel capacitor are being turned on starting from the center line and progressing outwardly until all of the pixel capacitors of the area are turned on.

In addition, the present invention provides another method for resolving display nonuniformity capable of achieving the aforementioned object, comprising the steps of:
(a1′) turning on a display screen;
(a2′) dividing the display screen into a plurality of areas;
(a3′) using the center line as a baseline in each area for separating the pixel capacitors of each area into left pixel capacitors and right pixel capacitors, and turning on the pixel capacitor arranged at the center line;
(a4′) turning on a right pixel capacitor arranged most adjacent to the center line after the pixel capacitor at the center line is turned on;
(a5′) turning on a left pixel capacitor arranged most adjacent to the center line after the pixel capacitor at the near-most right side of the center line is turned on; and
(a6′) turning on a right pixel capacitor just next to the previous turned-on right pixel capacitor and then turning on a left pixel capacitor just next to the previous turned-on left pixel capacitor, and so on, i.e. the pixel capacitor are being turned on starting from the center line and progressing outwardly until all of the pixel capacitors of the area are turned on.

It is another object of the invention to provide a method for solving display delay capable of minimizing the phenomenon of color lightening formed on partial areas of a screen by changing the turn-on sequence of the pixel capacitors, that is, the pixel capacitors in a area of a screen are turned on starting from the leftmost side or the rightmost side of the area and progressing inwardly toward the center line.

To achieve the abovementioned object, the present invention provides a method for resolving display nonuniformity, comprising the steps of:
(b1) turning on a display screen;
(b2) dividing the display screen into a plurality of areas;
(b3) using the leftmost side as a baseline in each area for starting a turn on sequence of pixel capacitors in each area, and turning on the leftmost pixel capacitor;
(b4) turning on a rightmost pixel capacitor after the leftmost pixel capacitor is turned on;
(b5) turning on a pixel capacitor just at the left to the leftmost pixel capacitor after the rightmost pixel capacitor is turned on; and
(b6) turning on a pixel capacitor just at the right to the rightmost pixel capacitor after the previous left-side pixel capacitor is turned on, and so on, i.e. the pixel capacitor are being turned on starting from the left most side and progressing inwardly toward the center alternatively from both side of each area until all of the pixel capacitors of the area are turned on.

In addition, the present invention provides another method for resolving display nonuniformity capable of achieving the aforementioned object, comprising the steps of:
(b1′) turning on a display screen;
(b2′) dividing the display screen into a plurality of areas;
(b3′) using the rightmost side as a baseline in each area for starting a turn on sequence of pixel capacitors in each area, and turning on the rightmost pixel capacitor;
(b4′) turning on a leftmost pixel capacitor after the rightmost pixel capacitor is turned on;
(b5′) turning on a pixel capacitor just at the right to the rightmost pixel capacitor after the leftmost pixel capacitor is turned on; and
(b6′) turning on a pixel capacitor just at the left to the leftmost pixel capacitor after the previous right-side pixel capacitor is turned on, and so on, i.e. the pixel capacitor are being turned on starting from the right most side and progressing inwardly toward the center alternatively from both side of each area until all of the pixel capacitors of the area are turned on.

The following descriptions of drawings and preferred embodiment could be taken in conjunction with the accompanying auxiliary drawings to specifically explain the present invention and facilitate examiner to examine the present invention.

### BRIEF DESCRIPTION OF THE DRAWINGS

FIG. 1 a schematic illustration showing a turn-on operation of pixel capacitors in the screen of a conventional LCD.

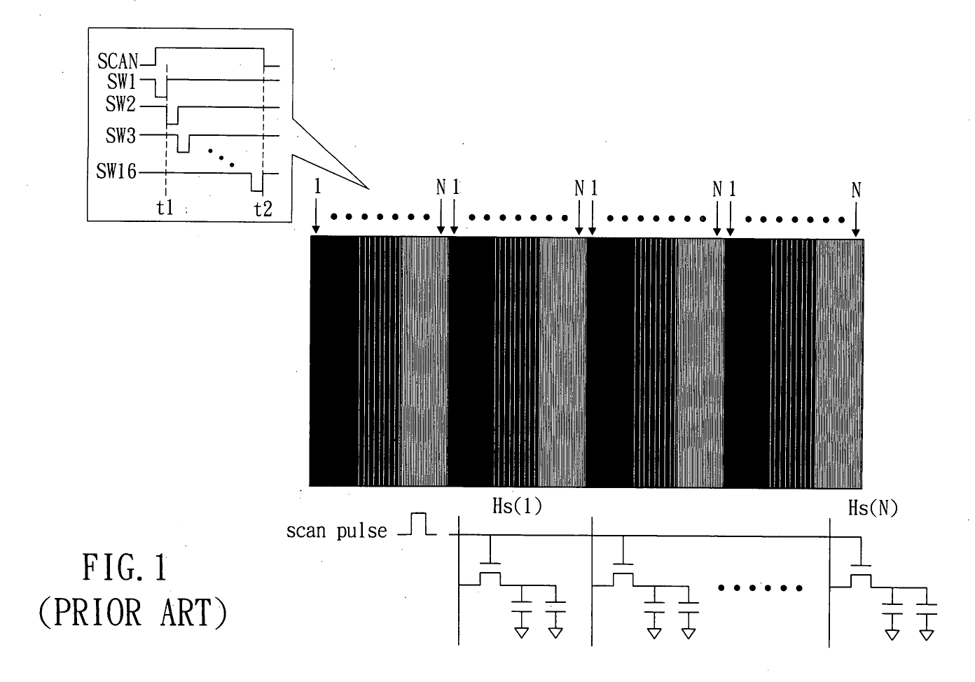

FIG. 2 is a schematic illustration showing a display screen being divided into a plurality of areas enabling the pixel capacitors in each area to be turned on using the center line as a baseline in accordance with the present invention.

FIG. 3 is a schematic illustration showing a turn-on sequence of turning on the pixel capacitors from the center line in sequence and progressing outwardly in accordance with the present invention.

FIG. 4 is a flow chart of the first embodiment of the present invention.

FIG. 5 is a flow chart of the second embodiment of the present invention.

FIG. 6 is a schematic illustration showing a turn-on sequence of turning on the pixel capacitors alternatively from both sides of each area and progressing inwardly to the center line in accordance with the present invention.

FIG. 7 is a flow chart of the third embodiment of the present invention.

FIG. 8 is a flow chart of the fourth embodiment of the present invention.

### DESCRIPTION OF THE PREFERRED EMBODIMENT

The advantages of the present invention together with the operation methods thereof, may be understood by reference to the following description taken in conjunction with the accompanying auxiliary drawings that facilitate examiner to comprehend the present invention. The operation methods of the present invention is not limited to the exemplify embodiments illustrated in the drawings.

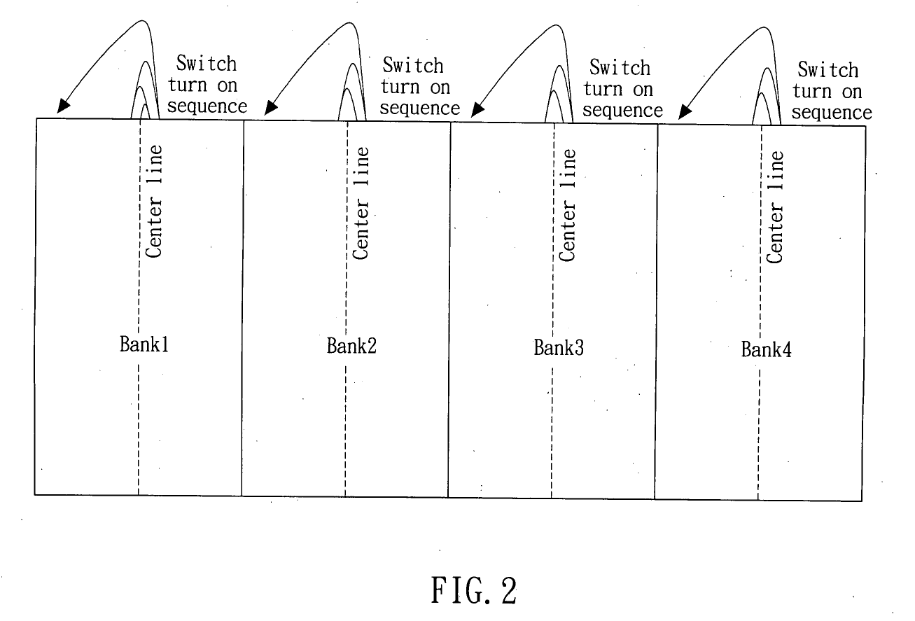

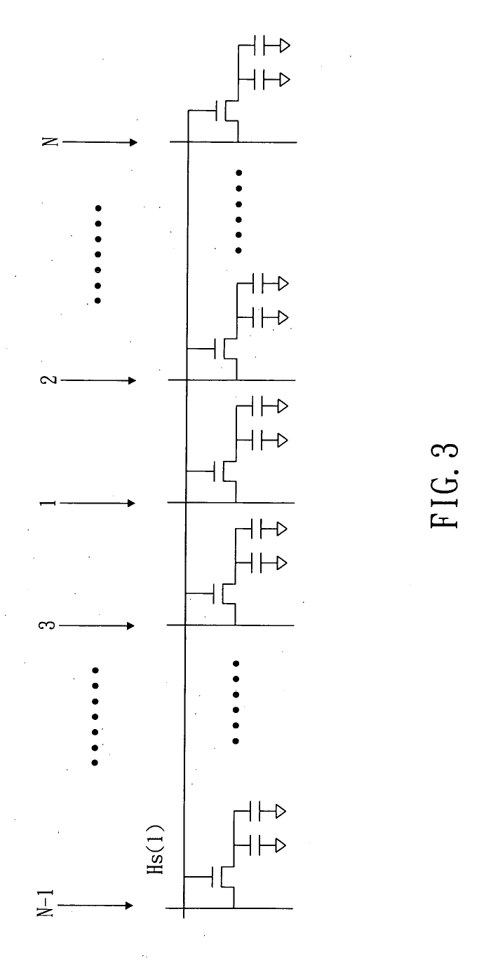

Referring to FIG. 2 and FIG. 3, which are respectively a schematic illustration showing a display screen being divided into a plurality of areas enabling the pixel capacitors in each area to be turned on using the center line as a baseline and a schematic illustration showing a turn-on sequence of turning on the pixel capacitors from the center line in sequence and progressing outwardly in accordance with the present invention. The phenomenon of color lightening formed on partial areas of the display screen is minimized by changing the turn on sequence of the pixel capacitors, wherein the center line is employed as a start point and the other pixel capacitor adjacent to the center line is turned on alternatively and progressing-outwardly from the center line. The first and second embodiments of the invention are performed in accordance with the principle described above.

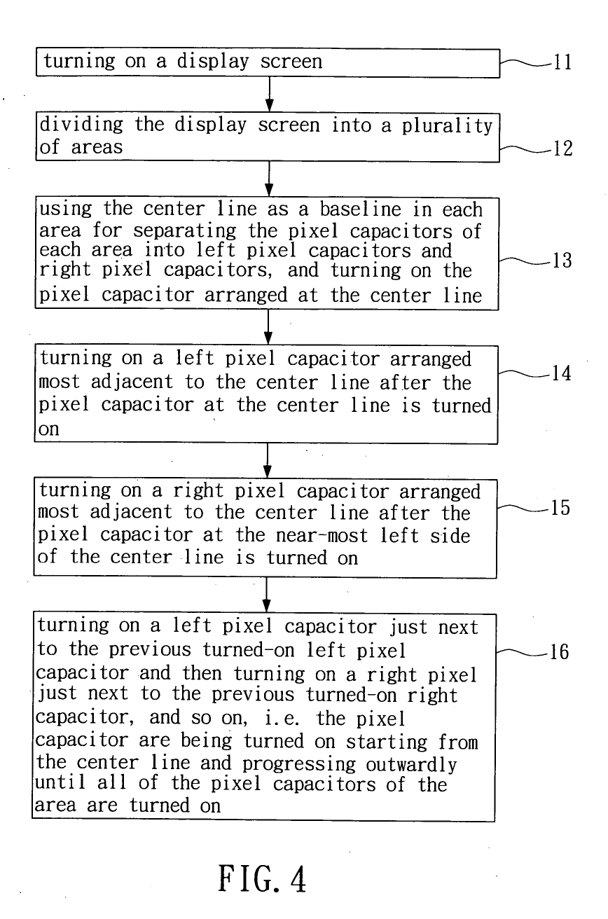

Please refer to FIG. 4, which is a flow chart of the first embodiment of the present invention. The method comprises the steps of:
(11) turning on a display screen;
(12) dividing the display screen into a plurality of areas;
(13) using the center line as a baseline in each area for separating the pixel capacitors of each area into left pixel capacitors and right pixel capacitors, and turning on the pixel capacitor arranged at the center line;
(14) turning on a left pixel capacitor arranged most adjacent to the center line after the pixel capacitor at the center line is turned on;
(15) turning on a right pixel capacitor arranged most adjacent to the center line after the pixel capacitor at the near-most left side of the center line is turned on; and
(16) turning on a left pixel capacitor just next to the previous turned-on left pixel capacitor and then turning on a right pixel just next to the previous turned-on right capacitor, and so on, i.e. the pixel capacitor are being turned on starting from the center line and progressing outwardly until all of the pixel capacitors of the area are turned on.

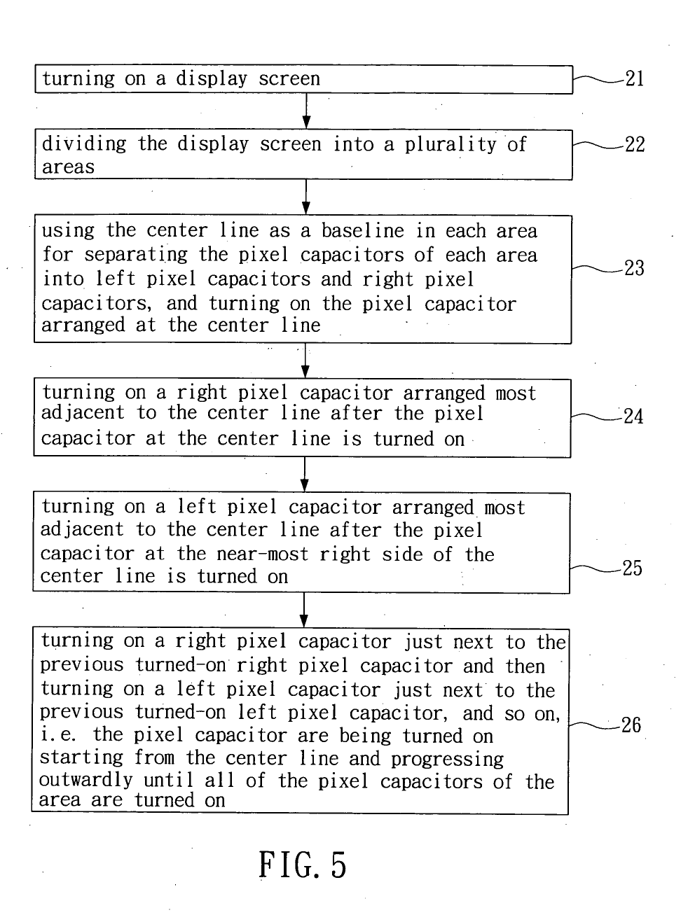

Please refer to FIG. 5, which is a flow chart of the second embodiment of the present invention. The method comprises the steps of:
(21) turning on a display screen;
(22) dividing the display screen into a plurality of areas;
(23) using the center line as a baseline (i.e. the position 1 shown in FIG. 3) in each area for separating the pixel capacitors of each area into left pixel capacitors and right pixel capacitors, and turning on the pixel capacitor arranged at the center line;
(24) turning on a right pixel capacitor arranged most adjacent to the center line (i.e. the position 2 shown in FIG. 3) after the pixel capacitor at the center line is turned on;
(25) turning on a left pixel capacitor arranged most adjacent to the center line (i.e. position 3 shown in FIG. 3) after the pixel capacitor at the near-most right side of the center line is turned on; and
(26) turning on a right pixel capacitor just next to the previous turned-on right pixel capacitor and then turning on a left pixel capacitor just next to the previous turned-on left pixel capacitor, and so on, i.e. the pixel capacitor are being turned on starting from the center line and progressing outwardly until all of the pixel capacitors of the area are turned on.

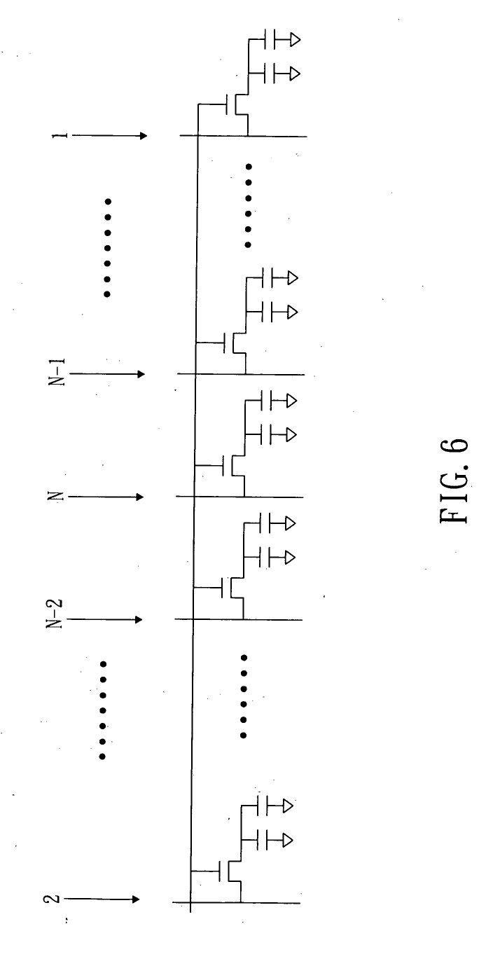

Please refer to FIG. 6, which is a schematic illustration showing a turn-on sequence of turning on the pixel capacitors alternatively from both sides of each area and progressing inwardly to the center line in accordance with the present invention. The phenomenon of color lightening formed on partial areas of the display screen is minimized by changing the turn on sequence of the pixel capacitors, wherein one side of two sides of the display area is selected as a start point and the pixel capacitors are turned on are turned on starting from the leftmost side or the rightmost side of the area and progressing inwardly toward the center line. The third and fourth embodiments are performed in accordance with the principle described above.

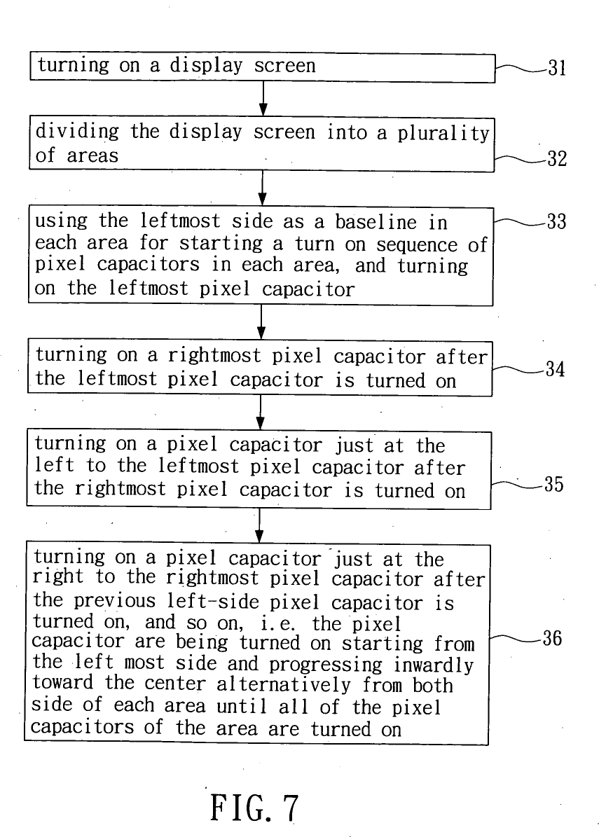

Please refer to FIG. 7, which is a flow chart of the third embodiment according to the present invention. The method comprises the steps of:
(31) turning on a display screen;
(32) dividing the display screen into a plurality of areas;
(33) using the leftmost side as a baseline in each area for starting a turn on sequence of pixel capacitors in each area, and turning on the leftmost pixel capacitor;
(34) turning on a rightmost pixel capacitor after the leftmost pixel capacitor is turned on;
(35) turning on a pixel capacitor just at the left to the leftmost pixel capacitor after the rightmost pixel capacitor is turned on; and
(36) turning on a pixel capacitor just at the right to the rightmost pixel capacitor after the previous left-side pixel capacitor is turned on, and so on, i.e. the pixel capacitor are being turned on starting from the left most side and progressing inwardly toward the center alternatively from both side of each area until all of the pixel capacitors of the area are turned on.

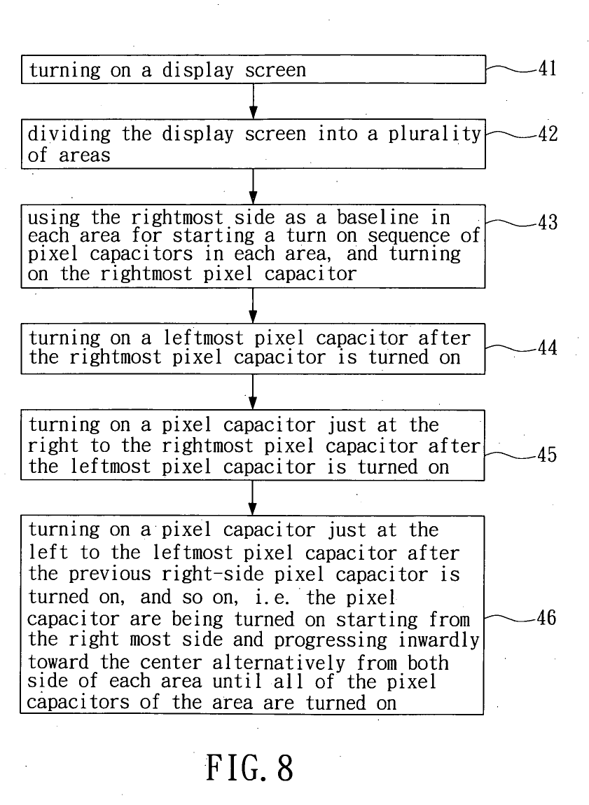

Please refer to FIG. 8, which is a flow chart of the fourth embodiment according to the present invention. The method comprises the steps of:
(41) turning on a display screen;
(42) dividing the display screen into a plurality of areas;
(43) using the rightmost side as a baseline in each area for starting a turn on sequence of pixel capacitors in each area, and turning on the rightmost pixel capacitor (i.e. the position 1 shown in FIG. 6);
(44) turning on a leftmost pixel capacitor (i.e. the position 2 shown in FIG. 6) after the rightmost pixel capacitor is turned on;
(45) turning on a pixel capacitor just at the right to the rightmost pixel capacitor after the leftmost pixel capacitor is turned on; and
(46) turning on a pixel capacitor just at the left to the leftmost pixel capacitor after the previous right-side pixel capacitor is turned on, and so on, i.e. the pixel capacitor are being turned on starting from the right most side and progressing inwardly toward the center alternatively from both side of each area until all of the pixel capacitors of the area are turned on.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments that do not depart from the spirit and scope of the invention.

What is claimed is:

1. A method for resolving display nonuniformity, comprising:
(a1) turning on a display screen;
(a2) dividing the display screen into a plurality of areas;
(a3) using the center line as a baseline in each area for separating the pixel capacitors of each area into left pixel capacitors and right pixel capacitors, and turning on the pixel capacitor arranged at the center line
(a4) turning on a left pixel capacitor arranged most adjacent to the center line after the pixel capacitor at the center line is turned on;
(a5) turning on a right pixel capacitor arranged most adjacent to the center line after the pixel capacitor at the near-most left side of the center line is turned on; and
(a6) turning on a left pixel capacitor just next to the previous turned-on left pixel capacitor and then turning on a right pixel just next to the previous turned-on right capacitor, and so on, i.e. the pixel capacitor are being turned on starting from the center line and progressing outwardly until all of the pixel capacitors of the area are turned on.

2. The method for resolving display nonuniformity as recited in claim 1, wherein the method is applied to a structure of a liquid crystal display (LCD).

3. A method for resolving display nonuniformity, comprising the steps of:
(a1′) turning on a display screen;
(a2′) dividing the display screen into a plurality of areas;
(a3′) using the center line as a baseline in each area for separating the pixel capacitors of each area into left pixel capacitors and right pixel capacitors, and turning on the pixel capacitor arranged at the center line;
(a4′) turning on a right pixel capacitor arranged most adjacent to the center line after the pixel capacitor at the center line is turned on;
(a5′) turning on a left pixel capacitor arranged most adjacent to the center line after the pixel capacitor at the near-most right side of the center line is turned on n; and
(a6′) turning on a right pixel capacitor just next to the previous turned-on right pixel capacitor and then turning on a left pixel capacitor just next to the previous turned-on left pixel capacitor, and so on, i.e. the pixel capacitor are being turned on starting from the center line and progressing outwardly until all of the pixel capacitors of the area are turned on.

4. The method for resolving display nonuniformity as recited in claim 3, wherein the method is applied to a structure of a liquid crystal display (LCD).

5. A method for resolving display nonuniformity, comprising the steps of:
(b1) turning on a display screen;
(b2) dividing the display screen into a plurality of areas;
(b3) using the leftmost side as a baseline in each area for starting a turn on sequence of pixel capacitors in each area, and turning on the leftmost pixel capacitor;
(b4) turning on a rightmost pixel capacitor after the leftmost pixel capacitor is turned on;
(b5) turning on a pixel capacitor just at the left to the leftmost pixel capacitor after the rightmost pixel capacitor is turned on; and
(b6) turning on a pixel capacitor just at the right to the rightmost pixel 25 capacitor after the previous left-side pixel capacitor is turned on, and so on, i.e. the pixel capacitor are being turned on starting from the left most side and progressing inwardly toward the center alternatively from both side of each area until all of the pixel capacitors of the area are turned on.

6. The method for resolving display nonuniformity as recited in claim 5, wherein the method is applied to a structure of a liquid crystal display (LCD).

7. A method for resolving display nonuniformity, comprising the steps of:
(b1′) turning on a display screen;
(b2′) dividing the display screen into a plurality of areas;
(b3′) using the rightmost side as a baseline in each area for starting a turn on sequence of pixel capacitors in each area, and turning on the rightmost pixel capacitor;
(b4′) turning on a leftmost pixel capacitor after the rightmost pixel capacitor is turned on;
(b5′) turning on a pixel capacitor just at the right to the rightmost pixel capacitor after the leftmost pixel capacitor is turned on; and
(b6′) turning on a pixel capacitor just at the left to the leftmost pixel capacitor after the previous right-side pixel capacitor is turned on, and so on, i.e. the pixel capacitor are being turned on starting from the right most side and progressing inwardly toward the center alternatively from both side of each area until all of the pixel capacitors of the area are turned on.

8. The method for resolving display nonuniformity as recited in claim 7, wherein the method is applied to a structure of a liquid crystal display (LCD).
